(19) United States
(12) Patent Application Publication
(10) Pub. No.: US 2007/0148457 A1
(43) Pub. Date: Jun. 28, 2007

(54) RADIATION ABSORPTIVE COMPOSITES AND METHODS FOR PRODUCTION

(75) Inventors: Aaron Wagner, Rochester, NY (US); Ronald R. Price, Stevensville, MD (US)

Correspondence Address: BASCH & NICKERSON LLP, 1777 PENFIELD ROAD, PENFIELD, NY, 14526, US

(73) Assignee: NaturalNano, Inc., West Henrietta, NY (US)

(21) Appl. No.: 11/531,459

(22) Filed: Sep. 13, 2006

Related U.S. Application Data
(60) Provisional application No. 60/717,533, filed on Sep. 14, 2005.

(51) Int. Cl. B05D 3/04; B05D 1/18; B05D 5/12; B05D 5/00; B32B 5/16

(52) U.S. Cl. 428/402; 427/305; 427/430.1; 427/96.3; 427/355; 427/421.1; 428/403; 428/425.9

(57) ABSTRACT

Disclosed are a radiation absorptive material and more particularly a method of economically coating halloysite or other mineral tubules (including nanotubules and microtubules) with a conductive metal (Cu) in order to produce an absorptive composite material capable of providing shielding and attenuation of radio-frequency signals.

This application claims priority and the benefit, under 35 U.S.C. §119, to the following U.S. Provisional Patent application, which is also hereby incorporated by reference in its entirety, U.S. Ser. No. 60/717,533, filed Sep. 14, 2005, for Radiation Absorptive Composites, by M. Weiner R. Price, S. Cooper, A. Angelica and R. Gunderman.

The present invention relates to a radiation absorptive material and more particularly to a method of economically coating halloysite or other mineral tubules (including nanotubules and microtubules) with a conductive metal in order to produce the radiation absorptive composite material.

### BACKGROUND AND SUMMARY

As electronic devices such as portable computing and communication equipment become increasingly compact, and the usage of such devices becomes more ubiquitous, there is a growing need to assure that the control of radiation emitted from or received by such devices is also controlled. For example, even small-scale improvements in the absorptive properties of materials used with electrical devices can have a significant impact on device size, weight and cost. Improved absorptive characteristics may also enable the efficient production of materials that exhibit radiation absorptive properties (e.g., absorbing radiation, providing for signal attenuation, and isolation of devices).

Composite materials and coatings have become quite common in man-made materials for construction, fabrication and the like. A polymer composite includes at least one polymer matrix or material in combination with at least one particulate filler material. The polymer matrix material may be any of a number of polymers including themoplastics such as polyamide (Nylon), poly-urethane, polyolefins, vinyl polymers, and the like, thermosets, and elastomers. Some of the most common nanoparticle fillers are two-dimensional nanoclays, one-dimensional carbon nanotubes, and zero-dimensional metal oxide nanoparticles such as Zinc Oxide (ZnO), Titanium Dioxide (Ti02), and Zirconia (ZrO). Composites offer the potential of materials having properties (e.g., radiation absorption, attenuation, shielding) that are not often available in naturally occurring raw materials. Moreover, the function of the composite, whether it be a component material or coating, often determines the characteristics desired. For example, in coatings, the strength of the composite may be less of a consideration than its adhesion to a surface (e.g., compatibility with the surface being coated) and uniformity of application (e.g., wetting/surface tension). Conversely, where the material is used to produce a component, adhesion and wetting may be less of a concern than say the hardness and yield strength of the composite.

One particular class of composite has demonstrated great promise in achieving such characteristics and overcoming the limitations and tradeoffs noted above—polymer nanocomposites. Nanocomposites generally include one or several types of nano-scale particles dispersed within a polymer matrix. The benefits of nanoparticles are derived from the very large surface area interactions of the nanoparticles with the polymer matrix. The nature of this interaction allows for beneficial property improvements, sometimes using fillers at very low loading levels as compared to alternative fillers. The possibility of using lower loading levels reduces the concerns relative to increased waste and costs, yet improves the potential for homogeneous dispersion of the filler within the composite matrix.

In view of these opportunities, the present disclosure includes aspects directed to ways in which nanocomposite fillers may be employed in coatings or in components to achieve desired characteristics, and more particularly, characteristics including radiation absorptivity, attenuation, shielding and the like. Such functionality is achieved, in one aspect, by “functionalizing” the nanocomposite filler, where the term functionalizing suggests a treatment of the filler so as to alter the material in some way such that it exhibits an added or improved function. One embodiment of the functionalization is the coating or introduction of a metallic material on a surface or portion of a nanotubular structure. Although described herein with respect to a particular nanotubular mineral filler, such as halloysite, it will be appreciated that various alternative nanotubular materials may also be employed. Other inorganic materials that will, under appropriate conditions, form tubes and other microstructures, include imogolite, cylindrite and boulangerite. Cylindrite and boulangerite also belong to the class of minerals known as sulfosalts.

The following patents and publications describe or characterize methods of accomplishing metallic coating on certain materials, as well as characteristics and uses of such materials. The following patents and publications are hereby incorporated by reference in their entirety for their teachings.
20060196764 filed Jan. 30, 2003, by P. Schoen et al., for Microwave-Attenuating Composite Materials, Methods for Preparing the Same, Intermediates for Preparing The Same, Devices Containing the Same, Methods of Preparing Such a Device, and Methods of Attenuating Microwaves;
20060193978; filed Mar. 14, 2006, by. R. Toth for Apparatus and Method of Treating Fine Powders;
20060183328; filed Aug. 12, 2005, by L. Barstad et al. for Electrolytic Copper Plating Solutions;
20060073335; filed Oct. 26, 2005, by M. Oyamada et al., for Conductive Electrolessly Plated Powder and Method for Making Same;
20060065537; filed Aug. 17, 2005 by L. Barstad et al., for Electrolytic Copper Plating Solutions;
20060062840 filed Aug. 29, 2005, by R. Price et al. for LIPID Microtubules With Contolled Bilayer Numbers;
20050272846 filed Jun. 4, 2004, by R. Price et al., for Waterborn Coating Containing Microcylindrical Conductors;
20050227074; filed Apr. 8, 2004, by M. Oyamada et al., for Conductive Electrolessly Plated Powder and Method For Making Same;
2004086656 filed Nov. 6, 2002, by P. Kohl et al., for Electroless Copper Plating Solutions and Methods of Use Thereof;
20040074778 filed Oct. 10, 2003, by. A. Cobley et al., for Plating Bath and Method for Depositing a Metal Layer on a Substrate; and
20030085132 filed Oct. 2, 2001 by. A. Cobley et al., for Plating Bath and Method for Depositing a Metal Layer on a Substrate.

From the teachings set forth above relative to coating of micro- or nanotubules, it was determined that coating mineral nanotubes (e.g., Halloysite) with a conductive layer such as copper and then adding these tubes to a paint or similar coating material or other composite will result in a coating providing radiation absorption or radio-frequency (RF) shielding characteristics. Previous work by the Naval Research Laboratory (see e.g., patent application 20050272846) utilized an electroless plating process for the coating of lipid microtubules, although requiring a precious-metal catalyst. The process used was taken from the Shipley Co. (Rohm and Haas) electroless plating procedure where the substrate is catalyzed with a palladium (Pd) salt solution, and then subjected to a copper plating bath. With the increase in precious metal prices and the complexity of controlling such processes, it has been further determined that a palladium-free plating procedure (i.e., does not use Pd as a catalyst) was desirable; and the following description sets forth the development and experimental results of a new coating procedure suitable for coating halloysite nanotubules (HNT) with metallic copper (Cu) without the need or use of a precious-metal catalyst.

Disclosed in embodiments herein is a method for the metallization of mineral nanotubes, comprising: preparing a plating bath consisting essentially of an aqueous solution and a metallic chloride; exposing a plurality of mineral nanotubes to said bath; and plating a surface of said nanotubes using a non-precious metal catalyst in association with said bath.

Further disclosed in embodiments herein is a method of electromagnetic shielding, comprising: providing a composition including cylindrically shaped, metal-coated particles and a polymer dispersion, where said metal-coated particles are produced using an electroless deposition process; applying the composition to a surface to be shielded; and curing the applied composition.

Also disclosed herein is a composite material, comprising: a polymeric matrix; and a plurality of metallized mineral tubules dispersed within at least a portion of said polymeric matrix, wherein said metallized mineral tubules are formed using an electroless, non-precious metal plating process.

### BRIEF DESCRIPTION OF THE DRAWINGS

FIG. 1 is a photomicrograph of halloysite clay nanotubes obtained from Nanoclay Technologies;

FIG. 2 is a photomicrograph of an halloysite clay nanotubes coated with metallic copper in accordance with an aspect of the disclosed embodiments; and

FIG. 3 is a graphical representation of comparative electron spin resonance data showing two samples of material prepared in accordance with Example 1 and a third sample prepared in accordance with an alternative process.

The various embodiments described herein are not intended to limit the invention to those embodiments described. On the contrary, the intent is to cover all alternatives, modifications, and equivalents as may be included within the spirit and scope of the invention as defined by the appended claims.

### DETAILED DESCRIPTION

As used herein the term “halloysite” is a naturally occurring clay of the chemical formula Al₂Si₂O₅(OH)₄.nH₂O; material that is believed to be the result of hydrothermal alteration or surface weathering of aluminosilicate minerals, such as feldspars. Halloysite in its hydrated form may also be referred to as endellite. Halloysite further includes tubular nanoparticles therein (halloysite nanotubes (HNT)).

A “platy clay” shall mean a layered inorganic clay material, such as a smectite or kaolin clay, this is in the form of a plurality of adjacent bound layers.

A “nanoparticle composite” or “nanocomposite” for short, is intended to include a composite material wherein at least one component comprises an inorganic phase, such as a halloysite material, with at least one dimension of the inorganic component is in the range of about 0.1 to 500 nanometers.

As used herein crude form halloysite refers to halloysite that is substantially unrefined (e.g., halloysite ore, with little or no further processing or refinement of the halloysite, per se). On the other hand, refined halloysite refers to processed halloysite where the nanotube content has been artificially increased by any of a number of processing and separation technologies. High nanotube content refined halloysite is particularly useful in the foregoing applications in view of its high strength to weight ratio (e.g., for structural reinforcement and for high loading capacity). As illustrated in the embodiments disclosed herein, use of the halloysite nanotube clay (crude or refined) as a filler in the nanocomposite material provides the ability to alter and improve the characteristics of composite materials in which it is added.

As more particularly set forth below, the disclosed materials and methods are directed to composites, particularly those suitable for use as coatings, and more particularly nanoclay nanocomposites utilizing mineral nanotubes, along with a method for preparing or functionalizing the nanotubes for use in such composites. The advantages of such composites are at least two-fold. First is the ease of processing. A nanotube filler material eliminates the need for exfoliation as required by other two-dimensional nanoclay fillers. The nanotubes are discrete nanoparticles and therefore need no additional chemical exfoliation to provide the desired dispersion. Furthermore, the tubular geometry provides a mechanism for increasing the binding of the tube to the composite matrix, and may provide lattice-type structures that are important in shielding applications. The polymer matrix may also traverse the inner open space or cavity of the tube structure, thereby increasing the interaction and bonding between the nanocomposite filler and the polymeric matrix.

The second advantage arises from the additional functionality that is possible with a tubular geometry as opposed to a laminar structure. This functionality is enabled by the ability to coat and/or fill the tubes with conductive agents such as metals or metal oxides. Advantages may also arise simply by virtue of the selective chemistry that occurs in certain tubes, where the inner surfaces have different reactivities than the outer surfaces—permitting the selective control and/or ordering of the nanotube structure within the composite.

In accordance with an embodiment of the invention, one such mineral nanotube that is naturally occurring is the halloysite nanotube. As described below, the halloysite nanoparticles have a generally cylindrical or scroll-like shape that is believed to be formed during weathering of the native hydrated clay, where the aluminosilicate forms a bilayer structure of distinct alumina and silica layers. The clay consists of subsequent bilayers held together by an intercalated water layer. One of the consequences of this bilayer structure is that the alumina layer and the silica layer differ in lattice structure—alumina being octahedrally bonded and silica being tetrahedrally bonded—where the lattice differences cause otherwise planar sheets of halloysite to curl and eventually form a scroll-like tube. More specifically, tetrahedral bonding results in a less constrained structure (i.e. greater degrees of freedom). Silica and alumina differ in their respective reactivities, which further leads to potentially useful characteristics of halloysite tubes not seen in either two-dimensional nanoclays or most other nanotubes.

Halloysite nanotubes typically range in length from about 100 nm to 40,000 nm (40 microns), with an average (dependent on the natural source) of about 1,200 nm. In one embodiment, the nanocomposite material includes halloysite nanoparticles having a mean average cylindrical length of at least about 100 nm to about 40,000 nm, and typically on the order of about 1,200 nm. Inner diameters of untreated nanotubes range up to about 200 nm with an average of approximately 40 nm, while outer diameters range from about 10 nm to 500 nm with an average of about 200 nm. In one embodiment, the nanocomposite material includes halloysite nanoparticles having a mean average outer cylindrical diameter of less than about 500 nm, and preferably on the order of about 200 nm. It may also be possible to characterize the nanotubes using a relationship between certain dimensions, e.g., an aspect ratio (length/diameter). In one embodiment it is believed that halloysite nanotubes may exhibit a length/diameter ratio of between about 0.2 to about 40,000, with an average aspect ratio of about 6.

Native halloysite is a hydrated clay with an intercalated water layer giving a basal spacing of about 10 Å. Subsequent drying of the clay can lead to the dehydrated form of the clay where the intercalated water has been driven off and the basal spacing reduced to 7 Å. Hydrated and dehydrated halloysite can be distinguished through X-ray diffraction. Dehydration is a naturally irreversible process, though researchers have had some success with artificially rehydrating the tubes with a potassium acetate treatment. In the hydrated form the intercalated water can be substituted out for small cations including organics such as glycerol.

Halloysite is a useful constituent of many polymeric composites for the purpose of mechanical and thermal property improvement, including those where the polymer is a coating (e.g., polyurethane), a film, a molded part, fiber, foam, etc., or in a composite where the polymer is a copolymer or terpolymer. Nanocomposites including halloysite nanotubes may also be used in embodiments where the filler is surface modified, including where the filler is coated for functionality (e.g., metallized or metal coated). In such embodiments, the coated HNT filler may be used for conductive coatings and shielding as described herein.

Alternatively, the filler may also be filled with an agent for elution (e.g. minerals, light emitting substances such as fluorescent or phosphorescent substances, colorants, antioxidants, emulsifiers, biocides, antifungal agents, pesticides, fragrances, dyes, optical brighteners, fire retardants, self-healing polymers, or mixtures and combinations thereof etc.), as described, for example, in U.S. Pat. No. 5,651,976 by Price et al., which is incorporated herein by reference in its entirety. Also contemplated is an embodiment where the filler, for example, HNT, is also filled with one or more materials such as colorants, antioxidants, emulsifiers, biocides, antifungal agents, pesticides, fragrances, dyes, optical brighteners, fire retardants, self-healing polymers and plasticizers, or where multiple fillers act in parallel to provide a plurality of properties or advantages including mechanical properties, whiteness, temperature resistance, etc. Such characteristics may be particularly important when used in nanocomposite coatings such as paints and the like. Paints and the like are known to be formed of acrylics, urethanes and other polymeric resins that may be spread to cover surfaces in varying thicknesses. For example, a “latex paint” is a formulated polyvinyl material with an acrylic resin.

Although other methods of applying the composite coatings such as paints and the like may be known, the present disclosure particularly contemplates the use of at least four general application methods. One such method is referred to as spreading and includes application of the coating via brush, roller, pad or doctor blade. Another well-known method is the application of paint or coating using a spraying process and includes air-fed and airless spray, hot spray, and electrostatic spray. Flow coating, as another alternative method of applying a nanocomposite coating, includes dipping, curtain coating, roller coating and reverse roller coating, and a final application method is electrodeposition.

The present invention further contemplates a concurrent or post-application process whereby the characteristics of the HNT filler materials may be controlled to achieve desired properties of the coating. Included in such processes are methods to produce a colloidal suspension and to then control the manner of drying the solution so as to maximize the effective density of the conductive filler (e.g., metal-coated HNT). Another potential way in which the characteristics of the composite coating may be controlled includes the application of an energy field to the coating while it is being applied, or while drying (curing), so as to maintain or control the structure or ordering of the conductive filler material in the coating. In such situations, electrostatic spraying, electrodeposition techniques, use of magnetic or other energy fields, and the like, may prove suitable to achieve desired structure that improves and/or “tunes” the applied nanocomposite coating. In other words, the manner or techniques employed for application of the coating and/or post-application processing may permit the control of certain characteristics of the coating—including tuning of the attenuation frequencies or amount of attenuation available from such coatings.

Although described herein with respect to a particular nanotubular mineral fillers, such as halloysite, it will be appreciated that various alternative materials may be similarly employed. Other inorganic materials that will, under appropriate conditions, form tubes and other microstructures, include imogolite, cylindrite and boulangerite. Cylindrite and boulangerite also belong to the class of minerals known as sulfosalts.

Polymeric composites and nanocomposites including metallized mineral nanotubes are described, and a method of preparation of such composites is disclosed herein and in the examples set forth below. An important aspect of the disclosed embodiments is the fact that a nanotube filler material eliminates the need for exfoliation, as required by other two dimensional nanoclay fillers. The tubes are discrete nanoparticles and, therefore, need no additional chemical exfoliation for dispersion. Furthermore, the tubular geometry provides a mechanism for increasing the binding of the tubes to the polymer matrix with minimum required surface modification of the nanotube.

In one aspect, the present invention may be employed to produce radiation absorptive coatings and/or substrates, comprising a polymer matrix and a plurality of functionalized mineral-derived micro-tubules or nanotubes dispersed within the polymer matrix. This composite is useful, for example, in paints and coatings, as well as in polymers and plastics that have application in, for example, the electronics, aerospace, automotive, building, and building products fields. In the building field, for example, compositions of the invention may be applied as paints or coatings sprayed or otherwise applied to the interior or exterior of a building, a vehicle or other structure (e.g., housing, enclosure) to be imparted with the benefits of the compositions. In one embodiment it is contemplated that paints or coatings made in accordance with this disclosure may be used to provide attenuation or shielding for building or building materials. They may be applied as part or all of building materials, including panels, paints, sealers, ceramics and the like.

In a further aspect, the polymer matrix may be selected from but is not limited to, a member of the group consisting of themoplastics such as polyamide (Nylon), poly-urethane, polyolefins, vinyl polymers, and the like, thermosets, and elastomers, and more particularly including acrylic urethane latex, nylon, polypyrole, polyurethane, and acrylic latex polymers. Acrylic urethane latex may be of the kind commonly available in consumer paints and wall coatings. Paints and coatings of the invention may avoid both the odor and the volatile organic content that is commonly associated with conventional paints, rendering such paints and coatings particularly suitable for interior architectural use. Those skilled in the art will, with the benefit of this disclosure, recognize that other polymer matrices may be effective in producing alternative compositions of the invention.

In one embodiment it is contemplated that the nanocomposite coating or composition may include between about 1 wt % to about 5 wt % of mineral-derived nanotubes and about 95 wt % to about 99 wt % of a polymer matrix material. Where the amount of nanotube filler and the amount of polymer matrix material do not comprise 100 percent of the composition, additional additives may include, for example, but are not limited to pigments, solvents (non-volatile or volatile), surfactants, and other well-known constituents of paints and composites.

In accordance with alternative embodiments of the present invention, it may also be advantageous to utilize a compatibilization agent to improve the bonding between the matrix material and the coated nanotubes. As described, for example, in U.S. patent application Ser. No. 11/469,128 for an “Improved Polymeric Composite Including Nanoparticle Filler,” filed Aug. 31, 2006 by S. Cooper et al., hereby incorporated by reference in its entirety, the surface of halloysite or other tubular clay materials may be modified to impart compatibility with the polymer binder. One possible approach is described in U.S. Pat. No. 6,475,696, which is also hereby incorporated by reference in its entirety. Compatibility may be enhanced through either similar cohesive energy density or bonding capacity of the polymer and filler or other specific interactions, such as ionic or acid/base interactions. Another class of useful compatibilization agents may include those that are covalently bonded to the layers of the inorganic nanotubes such as halloysite. It should be appreciated that such compatibilization agents would also be appropriate with the material employed to metallize the nanotubes.

Examples of various types of compatibilizing agents that may be useful for treating inorganic materials having nanotubular structures are included in, but not limited to, the disclosures of U.S. Pat. Nos. 4,894,411; 5,514,734; 5,747,560; 5,780,376; 6,036,765; and 5,952,093, which are hereby incorporated by reference in their entirety for their teachings. Treatment of a halloysite nanotube clay by the appropriate compatibilizing agents can be accomplished by any known method, such as those discussed in U.S. Pat. Nos. 4,889,885; 5,385,776; 5,747,560; and 6,034,163, which are also hereby incorporated by reference in their entirety. The amount of compatibilizing agent can also vary substantially provided the amount is effective to compatibilize the nanotubes to obtain a desired dispersion. Similarly, polymeric materials may effectively compatibilize polymer-HNT systems. Specifically, copolymers are often used, in which one type of monomer unit interacts with the HNT's, while the other monomer units interacts with the polymer (e.g., polypropylene-maleic anhydride).

Although several embodiments described herein are directed toward radiation absorptive coatings and/or substrate surfaces, it will be appreciated that aspects of the invention may be accomplished using alternative composite materials and processes for forming such materials. For example, in addition to the various application techniques set forth above, it may also be possible to produce devices or components that have similar radiation absorptive characteristics, or more generally conductivity variations, using the coated nanotube filler described herein in conjunction with various forming processes such as molding (e.g., compression, transfer, injection, blow, extrusion, expandable-bead, foam) compounding, extrusion (including extruded and oriented to form film or fibers), co-extrusion, rotomolding, thermoforming, vacuum forming, calendaring, matched-die molding, hand lay-up, filament winding, casting, and forging. It will be appreciated that in such processes, the metallized nanotubes may be dispersed within the composite material, or may be preferentially disposed adjacent surfaces. For example a co-extrusion or blow-molding operation may permit the metallized nanotube filler to be preferentially disposed adjacent the outer surface to produce a desirable characteristic (e.g., shielding).

### EXAMPLES

The practice of one or more aspects of the invention are illustrated in more detail in the following non-limiting examples:

### Example 1

Formation of Cu coated nanotubules—The coating of nanotubes with a metallic material was successfully accomplished using an electroless deposition process in a manner similar to that used for through-hole plating in circuit board preparation—see e.g., Rohm & Haas Circuposit™ circular CB04N041, Rev. 0; March 2004, and MSDSs for each of the Circuposit 370A (Ver 2.1; 5/15/2006), Cuposit Y (Ver 2.2; 4/27/06) and Cuposit Z (Ver 2.2; 4/27/2006) compositions, which are hereby incorporated by reference in their entirety. More specifically mineral nanotubes were metalized with Copper (Cu) using a non-Paladium, electroless process as will now be described.

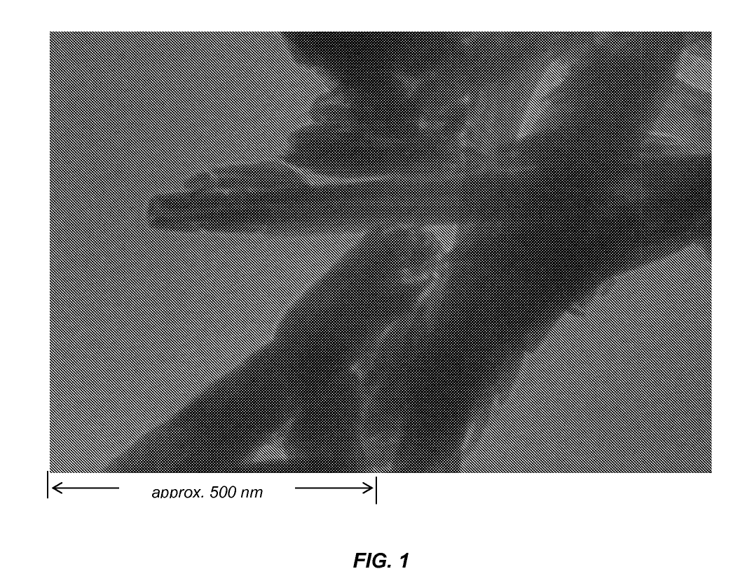

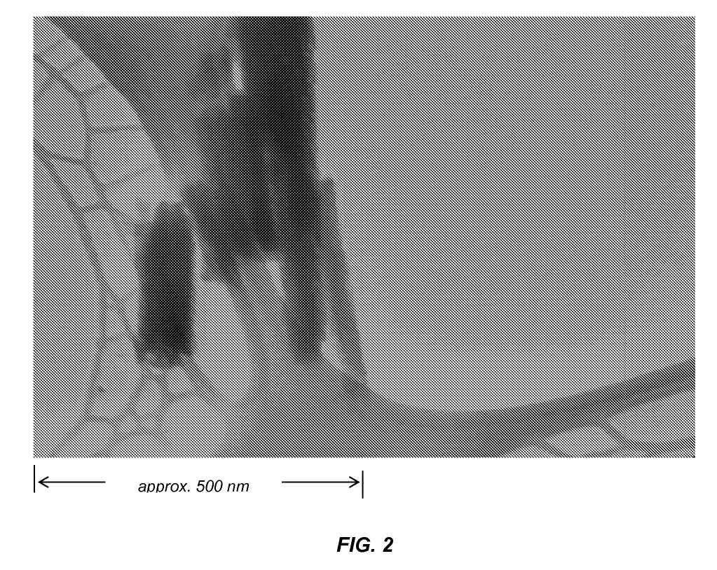

Halloysite nanotubes (NCT-HalloysiteEG, air milled; referred to as “HNT”) were coated with electroless copper (Cu) using a bath comprising Circuposit 370A (Rohm & Haas), Cuposit Y (Rohm & Haas), Cuposit Z (Rohm & Haas), 15 percent ethylenediaminetetraacetic acid (EDTA, tetra Na salt hydrate), deionized water, sodium borohydride NaBH4 (Acros), a water-soluble reducing agent, in accordance with the following steps, to produce about 1.0 liters of plating solution and coating about 2 grams of HNT:
a. The bath was prepared in a 1500 ml flask, using 750 ml of deionized water combined with 120 ml of EDTA solution, and 10 ml of Circuposit 370A (at least about 60% water and less than about 40% Copper chloride). A magnetic stirring bar was added to the flask and the bath was stirred while heating to approximately 115° F.
b. In a 200 ml beaker, 23 ml of Cuposit Z (a solution of less than about 30% sodium hydroxide and water) and the 2 grams of treated HNT (e.g., air milled HNT as depicted, for example, in FIG. 1) were added to 130 ml of deionized water and the mixture was “sonicated” (exposed to high-frequency energy causing the materials to intermix), for approximately 30 minutes to create a HNT slurry.
c. The HNT slurry was introduced to the bath at 115° F., and the resulting mixture was stirred for approximately 15 minutes.
d. The pH of the mixture was measured and recorded at 10.4.
e. Cuposit Y (a solution of less than about 25% formaldehyde and water) was then added to the mixture in a drop-wise fashion until the pH of the mixture reached about 11.0. Upon the addition of the formaldehyde, the plating bath was considered active, and it was expected that some level of copper would have been observed as plating out of solution.
f. The mixture was then placed in a vacuum oven for 10 minutes at a temperature of approximately 122° F., and the vacuum was applied to achieve a level of about 27 in-Hg before being released and returned to ambient pressure. In one embodiment, the vacuum was intended to encourage even or generally continuous coating and to fill voids. In an alternative approach, the application of a vacuum may promote plating in tubular recesses of the HNT, which may require application of a vacuum at different levels and/or longer periods of time.
g. No plating was observed to have started at this point and the temperature of the solution was dropped to approximately 85° F. and 1 milligram of sodium borohydride (NaBH₄), a water-soluble reducing agent, was added to initiate the reaction.
h. After approximately 10 minutes, the mixture turned from a pale blue color to a dark copper color.
i. The mixture was allowed to stir for another 30 minutes, after which the stirring was stopped and the heat turned off, and the mixture was allowed to “sit” for approximately 30 additional minutes.
j. The mixture was then divided into four 250 ml centrifuge bottles and centrifuged for about 7 minutes at a maximum speed (approximately 6000 rpm). It will be appreciated that alternative techniques such as filtering and decanting might also have been sued for such separation.
k. The liquid was poured off of each container and the mixtures were re-slurried by adding fresh deionized water, and the process of centrifuging and draining was repeated.
l. The solids were removed from the centrifuged mixtures using isopropyl alcohol (IPA) and were placed in a container.
m. Solids were allowed to dry and were subsequently tested for conductivity.
n. Another portion of the solids were diluted with excess IPA and were observed in a CM10 transmission electron microscope. Photomicrographs of the resultant copper-coated tubules are found in FIG. 2.

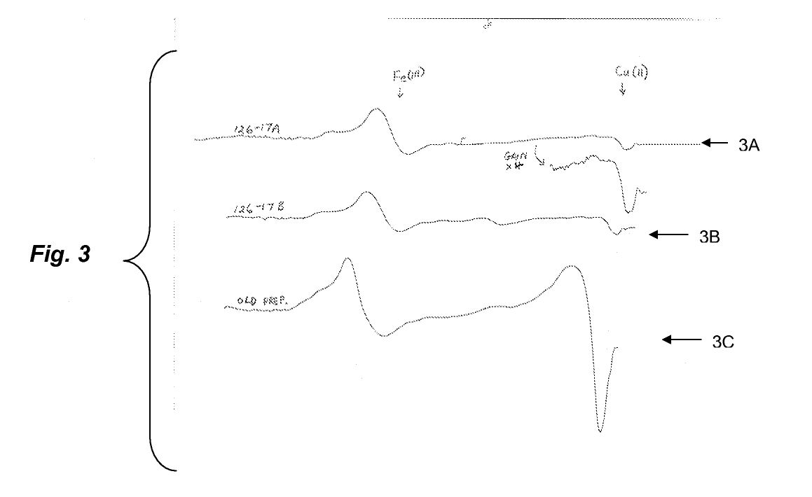

In accordance with the process set forth in Example 1, it is believed that a coating of metallic copper having a thickness in the range of about 1 to about 20 nanometers was achieved. To verify the presence of metallic copper coating, a sample of the metallized nanotube material produced was studied using electron spin resonance and the resulting spectra are depicted in FIG. 3. More specifically, FIG. 3 demonstrates two curves, 3A and 3B, where both curves indicate little response in the region indicating the presence of Cu ions (non-metallic copper), as contrasted for example in curve 3C. The lower response of curves 3A and 3B, as contrasted to 3C indicates that the samples associated with samples 3A and 3B have metallic copper present on the nanotubes processed in accordance with the Example.

### Example 2

Example 2 is a prophetic example and provides a composite coating material that is believed to demonstrate electromagnetic attenuation when the metallized HNT filler is applied in the coating layer such that the filler is dispersed in the coating layer to form a “lattice” of metallized HNT. A coating comprising copper-coated halloysite nanotubules (prepared in accordance with the method of Example 1) and acrylic urethane latex may be prepared. The coating would be applied by spray or other method to a Mylar® (E.I. Du Pont de Nemours and Co.) backing at a rate or thickness suitable to provide a continuous coating. It is believed that such a coating may achieve an attenuation of several decibels and up to about 40 db over a range of frequencies from about 30 MHz to about 1500 MHz. Thin layers or coatings of the metallized HNT composite coating material may assure the close spacing of the metallized filler within the coating layer, thereby assuring or improving the attenuation effectiveness of the coating.

Also, the addition of Silver (Ag), Nickel (Ni) or Gold (Au) to reduce the oxidation of the metallic copper coating may be applied in a plating bath or similar process (e.g., Ni-Chloride, Silver Nitrate or other plating materials). Such materials may provide blocking sites to prevent the metallic copper from oxidizing. It may also be the case that such additional deposits of conductive materials further improve the performance in attenuation achieved using the metallized nanotube filler.

### Example 3

This prophetic example is directed to a paint provided containing the composite coating of Example 2. The paint includes functionalized (e.g., metallized) halloysite nanotubules, a water carrier, an acrylic urethane latex based binder, and optionally one or more pigments or other additives. Additives may be selected from, for example, but not limited to, thickeners, surfactants, biocides, defoamers, and cosolvents. The paint would then be applied to an interior or exterior surface as set forth in Example 4, below.

### Example 4

This prophetic example describes a coating or paint as set forth in Example 2 and/or Example 3 and which may be applied as a paint or coating to the interior surfaces of a building or enclosure. The coating attenuates or blocks electromagnetic radiation with frequencies from about 30 MHz to about 20 GHz.

### Example 5

Example 5 is a prophetic example. A composite of the invention is combined with a building material (e.g., a ceramic, a plaster or surface-applied compound (e.g. drywall joint compound)). The building material attenuates or blocks an effective amount of electromagnetic radiation. Aspects of the disclosed invention may also be used in composites as described for example in U.S. patent application Ser. No. 11/469,128 for an “IMPROVED POLYMERIC COMPOSITE INCLUDING NANOPARTICLE FILLER,” filed Aug. 31, 2006 by S. Cooper et al., previously incorporated by reference in its entirety.

It will be appreciated that various of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A method for the metallization of mineral nanotubes, comprising:
preparing a plating bath consisting essentially of an aqueous solution and a metallic chloride;
exposing a plurality of mineral nanotubes to said bath; and
plating a surface of said nanotubes using a non-precious metal catalyst in association with said bath.

2. The method of claim 1, wherein preparing a plating bath includes preparing a bath using deionized water EDTA solution, and a copper chloride in an aqueous solution.

3. The method of claim 1, wherein exposing a plurality of mineral nanotubes to said bath includes:
preparing a mineral nanotube slurry including sodium hydroxide in an aqueous solution, mineral nanotubes, and deionized water;
sonicating the slurry to mix and distribute the mineral nanotubes; and
introducing the mineral nanotube slurry to the bath to create a mixture.

4. The method of claim 3, wherein said mineral nanotubes include halloysite nanotubes.

5. The method of claim 3, further comprising:
adding formaldehyde to the mixture; and
increasing the pH of the mixture to catalyze the metallization process.

6. The method of claim 5, further comprising:
applying heat and vacuum to the mixture, and subsequently returning the mixture to ambient pressure;
adding a water-soluble reducing agent; and
stirring the mixture.

7. The method of claim 1, further comprising separating metallized solids from liquid in the bath.

8. The method of claim 7, wherein the process for separating the solids from liquid is selected from the group consisting of: filtering; decanting; and centrifuging.

9. The method of claim 6, further comprising:
centrifuging the mixture;
removing liquid from the centrifuged mixture and re-hydrating the mixture with deionized water;
repeating the steps above as necessary until the solids have been thoroughly rinsed;
removing the solids using isopropyl alcohol; and
drying the solids.

10. A method of electromagnetic shielding, comprising:
providing a composition including tubular, metal-coated particles and a polymer dispersion, where said metal-coated particles are produced using an electroless non-precious metal catalyst process;
applying the composition to a surface to be shielded; and
curing the applied composition.

11. The method of claim 10, wherein said tubular, metal-coated particles are halloysite nanotubes coated with electroless copper over at least one surface thereof.

12. The method of claim 11, further including coating said halloysite nanotubes with electroless copper using a process comprising:
preparing a plating bath consisting essentially of an aqueous EDTA solution and copper chloride;
exposing a plurality of halloysite nanotubes to said bath by preparing a halloysite nanotube slurry including sodium hydroxide, halloysite nanotubes, and deionized water;
sonicating the slurry to mix and distribute the nanotubes; and
introducing the slurry to the bath to create a mixture; and
plating a surface of said nanotubes using a non-precious metal catalyst in association with said bath

13. The method of claim 12, further comprising adding formaldehyde to the mixture to catalyze the metallization process.

14. The method of claim 13, further comprising:
applying heat and vacuum to the mixture, and subsequently returning the mixture to ambient pressure;
adding a water-soluble reducing agent; and
stirring the mixture.

15. The method of claim 10, wherein said polymer dispersion includes a polyvinyl material with acrylic resin.

16. The method of claim 10, wherein applying the composition to a surface includes a method selected from the group consisting of:
spreading;
flow-coating;
spraying; and
electrodeposition.

17. A composite material, comprising:
a polymeric matrix; and
a plurality of metallized mineral tubules dispersed within at least a portion of said polymeric matrix, wherein said metallized mineral tubules are coated using an electroless, non-precious metal plating process.

18. The material of claim 17, wherein said tubules include halloysite nanotubules.

19. The method of claim 18, wherein said halloysite nanotubules include metallic copper on a surface thereof.

20. The material of claim 17, wherein said polymeric matrix includes an acrylic urethane latex paint.

21. The material of claim 20, wherein said acrylic urethane latex paint is applied to the surface of an object.

22. The material of claim 17, wherein the material is formed into a component using a process selected from the group consisting of: molding, compounding, extrusion, co-extrusion, rotomolding, thermoforming, vacuum forming, calendaring, matched-die molding, hand lay-up, filament winding, casting, and forging.
